(19) United States
(12) Patent Application Publication
(10) Pub. No.: US 2012/0092105 A1
(43) Pub. Date: Apr. 19, 2012

(54) FLEXIBLE METHODS OF FABRICATING ELECTROMAGNETS AND RESULTING ELECTROMAGNET ELEMENTS

(75) Inventors: Irving N. WEINBERG, Bethesda, MD (US); Pavel STEPANOV, North Potomac, MD (US); Mario URDANETA, Berwyn Heights, MD (US); William PETER, Bethesda, MD (US)

(73) Assignee: WEINBERG MEDICAL PHYSICS LLC, Bethesda, MD (US)

(21) Appl. No.: 13/242,386

(22) Filed: Sep. 23, 2011

Related U.S. Application Data
(60) Provisional application No. 61/385,662, filed on Sep. 23, 2010.
(60) Provisional application No. 61/451,978, filed on Mar. 11, 2011.

(51) Int. Cl. H01F 5/00; H01R 43/00; B05D 3/02; B05D 5/00; B05D 3/06

(52) U.S. Cl. 335/296; 427/58; 427/559; 29/825

(57) ABSTRACT

An electromagnetic structure is fabricated by additive manufacturing having at least one channel traversing the structure. In one embodiment, at least one form contains apertures and/or holes forming the channel and a liquid metal traverses the structure by the channel. Electrodes are provided to apply or extract electrical voltage or power to and/or from the liquid metal as well as a mechanism for propelling a portion of the liquid metal through the form. In an alternative embodiment, both the electrically insulating and the electrically conductive materials are solid and the channel is used for conducting a coolant instead of the liquid metal.

### PRIORITY CLAIM

This patent application claims priority to U.S. Provisional Patent Application No. 61/385,662, filed Sep. 23, 2010, entitled “Flexible Methods of Fabricating Electromagnets,” and U.S. Provisional Patent Application No. 61/451,978, filed Mar. 11, 2011, entitled “Flexible Methods of Fabricating Electromagnets,” the disclosures of which are incorporated herein by reference in their entirety.

### FIELD OF THE INVENTION

Disclosed embodiments are directed, generally, to the fabrication of electromagnetic elements for the purposes of, for example, magnetic resonance imaging and energy conversion, storage and generation.

### DESCRIPTION OF THE RELATED ART

Conventionally, it is known that magnetic fields can be concentrated using flowing liquid conductors. For example, H H Kolm and O M Mawardi, in an article entitled “Hydromagnet: A Self-Generating Liquid Conductor Electromagnet”, published in the Journal of Applied Physics, Volume 32, Number 7, July 1961, described a system in which channels of liquid sodium-potassium were propelled into pipes that traversed a magnetic field which had been previously created with a conventional (i.e., wired) electromagnet. In the system of Kolm, the presence of the channels of liquid metal had the effect of concentrating the magnetic field created by the conventional electromagnet.

Until recently, liquid metals were difficult to handle due to their corrosive nature, or in the case of mercury due to unhealthy vapors. In the past two decades, a relatively non-toxic form of liquid metal (galinstan) has been promoted as a replacement for mercury in thermometers and syringes. An example of such use is given by M Knoblauch, J M Hibberd, J C Gray, and A J E van Bell, in the article entitled “A galinstan expansion femtosyringe for microinjection of eukaryotic organelles and prokaryotes”, published in the journal Nature Biotechnology, Volume 17, September 1999. It is known that galinstan can be used in conjunction with micromachined channels, as taught by Xu Wang in his Master's thesis from the School of Engineering at the Simon Fraser University in 2009, and by A Cao, P Yuen, and L Lin, in their publication entitled “Bi-Directional Micro Relays with Liquid-Metal Wetted Contacts”, published in the Proceedings of the 2005 IEEE International Conference on Micro Electro Mechanical Systems.

It is also conventionally known that liquid metal can act to protect the walls of a nuclear reactor, by healing itself in the case of radiation damage, as taught by L C Cadwallader, in the article “Gallium Safety in the Laboratory”, published by the Energy Facility Contractors Group in their 2003 Annual Meeting, and by N B Morley and J B Burris, in the article entitled “The MTOR LM-MHD Flow Facility, and Preliminary Experimental Investigation of Thin Layer, Liquid Metal Flow in a 1/R Toroidal Magnetic Field”, published in the journal Fusion Science and Technology, Volume 44, July 2003.

Further, additive manufacturing has become more popular in the past years and the public has realized that this may start a new era of manufacturing and rapid prototyping. This type of manufacturing allows construction of a three-dimensional object, which is usually achieved through successive deposition operations of materials onto portions of a structure, wherein the relative distance between the structure and the deposition tool incrementally changes between some or all of the deposition operations. A short summary about the technique and possibilities of additive manufacturing is given in the brochure titled: “Direct Manufacturing part one: What is Direct Digital Manufacturing?” published by Stratasys Inc. in 2009 describing their Fortus 3D Production systems.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with disclosed embodiments, the provision and application of liquid metals is performed using equipment components in a manner which provides electromagnetic coils constituted of the liquid metals. The use of such liquid metals enables particularly narrow and curvaceous channels that may emulate woven wires (known as Litz wires, from the German), within pre-fabricated forms. The design of such electromagnetic coils may be implemented using computer aided design techniques and fabricated using additive manufacturing techniques. The principle of Litz wire is that at high frequency, currents travel at the surfaces of conductors. As a result, increasing the surface area of conductors (i.e., by braiding multiple small wires) utilizes the conductive material more effectively than a single wire with a cross-sectional area that is the sum of the cross-sectional area of all the smaller wires.

In at least one embodiment, dynamic control of the channels conducting the liquid metal may be performed so as to enable changes in the coil configuration when appropriate.

Further, disclosed embodiments may enable cooling of the liquid metal in an efficient manner to remove impurities or other environmental factors that can impair operation.

Various disclosed embodiments involve provision of magnetic material in the vicinity of the form(s), in order to generate, convert, or store electrical power, or to concentrate or otherwise modify the magnetic field(s).

Further, disclosed embodiments provide a process for fabricating electromagnets by using additive manufacturing, wherein the electromagnets may have solid material as a conductor.

In at least one embodiment, a very efficient cooling scheme is employed within the electromagnet having solid conductive and insulating materials.

In at least one embodiment, a very efficient cooling scheme may be employed within the electromagnet, wherein the electromagnet has porous or other channels in conductive materials utilized to provide the electromagnet, wherein coolants may travel within the porous material or other channels.

In at least one embodiment, an inverse problem design may be fabricated to generate magnetic fields in a specified manner or with specified characteristics using computer-aided design to prescribe the fabrication process.

### BRIEF DESCRIPTION OF THE DRAWINGS

A more complete understanding of the present invention and the utility thereof may be acquired by referring to the following description in consideration of the accompanying drawings, in which like reference numbers indicate like features, and wherein:

FIG. 1 illustrates one example of the configuration of the form for a single coil, which contains a set of channels in accordance with a disclosed embodiment.

FIGS. 2a-2e illustrate an example of the use of additive manufacturing to create assemblies of channels with fractal patterns in accordance with a disclosed embodiment. As disclosed, the channels may be filled with conductive fluid, or may be filled with non-conductive coolant and used in conjunction with other conducting traces, or some combination of these or other uses.

FIGS. 3a-3c illustrate an example of a process for fabricating woven conducting layers in accordance with a disclosed embodiment.

FIGS. 4a-4c illustrate a process of fabricating a combination of a fractal cooling pattern as in FIG. 2 and the woven conductive layer pattern of FIG. 3 through additive manufacturing of in accordance with a disclosed embodiment.

FIGS. 5a-5d illustrate a process for fabricating a roof of material over a groove in order to create a channel in the additive manufacturing process in accordance with a disclosed embodiment.

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

Throughout this disclosure, the term “electromagnet” is used to refer to electromagnetic material and also to electromagnetic elements and devices using such elements. Accordingly, the term “electromagnet” should broadly be interpreted to include many types of structures and devices with electromagnetic properties and/or using electromagnetic materials or elements.

In accordance with at least a first disclosed embodiment, liquid metal is provided and manipulated by equipment components to implement an electromagnetic device. This equipment includes a form or forms, at least one of which contains apertures and/or holes as well as a liquid metal which traverses one of more of the apertures or holes of the form. In such case, the form would typically be comprised of an insulating material or materials. Alternatively, in accordance with any of the embodiments disclosed herein, at least one of the apertures or holes may be located within a solid conductor, for example, in a porous form of the conductor, through which the liquid metal or another liquid such as a coolant may travel. As explained herein electrodes are provided so as to externally apply or extract electrical voltage or power to and/or from the liquid metal. A means of propelling a portion of the liquid metal through the form(s) is also provided as well as a means of removing heat from, or adding heat to the liquid metal.

Alternatively, one or more control structures are present within the form, so that channels of the liquid metal may be closed or open by turning on/off the control structures, or flow may be redirected according to the configurations of the control structure(s).

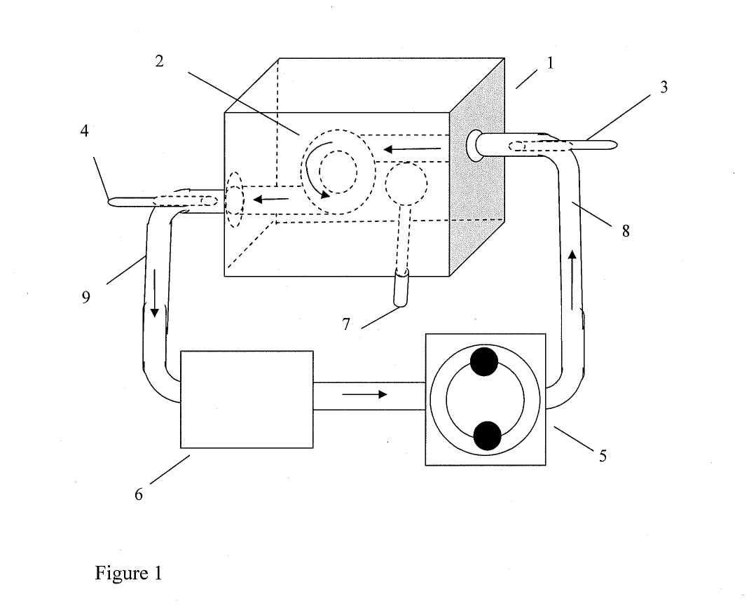

FIG. 1 illustrates an example of a single coil configuration provided in accordance with the first embodiment. As shown in FIG. 1, the form 1 may contain at least one, and optionally, a plurality of channels 2. For illustrative purposes, the direction of flow of the liquid metal is shown by arrows. Electrodes 3, 4 are provided to externally apply voltage to the liquid metal. A pump 5 is provided to squeeze a tube containing the liquid metal 8 propelling the liquid metal within the form 1. The pump 5 may also be configured or controlled to also interrupt flow and thereby isolate the pump electrically from the rest of the circuit. A purifier 6 is shown schematically and may be configured to scavenge oxygen, contaminants, or add chemicals in order to alter the behavior of the liquid metal. A control structure or valve 7 enables the direction and volume of one or more of the channels 2 to be modified as needed.

The “form” 1 may be implemented using any container(s) or other physical structure(s) that can contain at least a portion of the liquid metal 8. The form 1 may be partially or completely constructed through rapid prototyping or rapid manufacturing techniques. Rapid prototyping techniques may include the automated construction of physical objects using additive manufacturing technology, for example layer-by-layer.

For the purpose of the above described embodiments, the form may be made of an electrically-insulating material. Alternatively, the walls of the form may be made of one or more semiconducting materials, for example silicon, or combinations of one or more material.

The form 1 may contain interleaving channels so as to simulate a woven (Litz) wire configuration, which as described above is known to reduce electrical resistance at high frequencies. The cross-sectional shape of the channel is not restricted to circular, and may be of rectangular or other shapes. Further, the liquid metal may pass through a chamber in which oxygen or other materials are removed, which may be helpful in eliminating oxides or other chemicals or materials that can affect flow or heat transfer. Further, the liquid metal may travel via pores or other channels in a conductive or nonconductive section of the electromagnet, thereby cooling the electromagnet and/or increasing the effective conductive volume of the electromagnet.

An example of liquid metal 8 is galinstan, an alloy of gallium, indium, and tin, which is known to be liquid at room temperature. Other liquid metals and/or alloys or electrical conductors can be used as well.

In accordance with disclosed embodiments, the conductive section of the electromagnet may have a resistivity less than 10⁻⁸ Ω-m.

An example of the means of propelling the liquid metal is the roller pump 5 that may be external to the form, and which is connected to the form by some type of connection including one or more tubes 9. The roller pump 5 may optionally act as a switch to electrically isolate the pump 5 from the rest of the electrical circuit formed by the liquid metal 8. Alternatively, a portion of the liquid metal 8 may be propelled through via electromagnetic forces applied by electrodes (not sown) using a technique commonly known as MagnetoHydroDynamic (“MHD”) propulsion. MHD propulsion can be performed with direct current, alternating current, a traveling magnetic field, or a thermoelectric pump, as discussed by K Polzin in a report entitled “Liquid-Metal Pump Technologies for Nuclear Surface Power”, a publication by NASA in March 2007.

In one optional implementation, particles and nanoparticles may be dispersed in the liquid metal and may be used to propel or enhance the propulsion of the liquid metal by pushing on the liquid metal while the particles undergo magneto-electromechanical forces (e.g., magnetophoresis, dielectrophoresis, electrophoresis). Thus, it should be appreciated that, although the above-disclosed embodiments specify use of liquid metal conductors, the electromagnetic media may include other flowing conductive material, such as gases, solutions, plasmas, slurries, etc. Additionally, the liquid metal or other flowing conductors may also include additives that enhance the electrical conduction of the flowing conductor, the magnetic effects, or the movement of the flowing conductor. These additives may or may not be electrically conductive. Examples of such additives are iron oxide particles, silicon dioxide particles, and hexane.

In accordance with one optional implementation, a control structure may be used to alter the configuration of the form 1. That control structure (not shown) may be, for example, a bladder made of rubber or plastic or other material that is filled with air or otherwise deformed or re-positioned in order to compress or deflect a flexible portion of the form. In accordance with at least one implementation of the first embodiment, multiple control structures can be applied under computer guidance to convert the electromagnet from one physical configuration to another physical configuration. Alternatively, the flow pattern of the liquid metal 8 included in the form 1 may be partially or completely defined by inflatable walls in the form 1 that may be inflated and deflated, partially or fully, to form the channels 2. Alternatively, the control structure(s) may incorporate one or more solenoid valves to actuate inflation or deflation.

Utility of the disclosed embodiments is exemplified by, for example, application of the fabricated electromagnetic elements to magnetic resonance imaging, in which magnetic gradients are conventionally created by flowing currents in copper wires that are cooled with neighboring water pipes. The strength of the magnetic gradients (and/or the duty cycle of the electromagnets) in conventional systems is often limited by the ability of the water to cool the copper wires. However, in accordance with the disclosed embodiments, cooling of conducting material is improved through the advection or circulation of the heated material.

The terms “electromagnet,” “electromagnetic structure,” “electromagnetic material,” and “electromagnetic device,” as used in this application should be understood as corresponding to materials and/or structures or parts that create electromagnetic fields when power is applied to the conductive parts of the structure, part, device, etc. In accordance with at least one disclosed embodiment, the magnetic field strength H produced by the device or structure is at least one Gauss.

In accordance with at least a second disclosed embodiment, the electrically conductive substance may be solid, patterned and deposited, in part or in full, through rapid prototyping methods or additive manufacturing, for example, which involve the step-wise deposition of electrical conductors and electrical insulators. Spaces and channels can be left unfilled, or filled temporarily with a sacrificial material, in order to conduct coolant materials such as water. Spaces within the conductive or insulating substance or substances may be produced as pores or channels.

Thus, at least one fabrication process in accordance with disclosed embodiments involves selectively depositing precursors that upon processing of the device result in electrical conductors or insulators as needed for function. As an example, conductive material such as Aluminum can be transformed into an insulator through addition of oxygen.

Typical precursors of conductors include colloids and/or pastes containing small spheres of metal. The use of flakes instead of the spheres used in prior art in the precursor material has the advantage that the sintering temperatures and times required to achieve good conductivity can be reduced. Additionally, using precursor colloids containing reduced amounts of solvent as compared to conventional precursor colloids, for example colloids with less than 30% solvent by volume, leads to improved fidelity of the part shape, because of reduced expansion of the solvent component during phases of the fabrication process that involve high temperatures, or reduced deformation and/or shrinkage of the precursor material as the solvent evaporates, or reduced voids left from volume once occupied by the solvent.

It should also be understood that the deposition of insulating materials and corresponding precursors may use polyimides and polycyanurates and blends or co-polymers because these substances exhibit high electrical breakdown strength, low dielectric constant, and can tolerate high temperatures during the fabrication process. Further, the addition of particles with microscopic sizes, for example of alumina, can improve the fabrication process and/or part performance by affecting the viscosity of the host material as it is deposited, and can modify the dielectric strength of an insulator. It should be understood that other materials with a high electrical breakdown strength, a low dielectric constant, or a tolerance to high heat may be used as insulating materials. Examples of such materials include thermosetting plastics and ceramics.

It should further be understood that the fabrication process may include the transfer of energy to the fabricated structure in the form of heat, light, or other forms of electromagnetic radiation. Accordingly, controlled heating can be applied from a radiating element that is translated or otherwise rastered over the fabricated form's face during an iterative process in the additive manufacturing process in order to sinter or otherwise cure materials that have been deposited. For example, a part of the device or structure to be fabricated may be exposed to light or heat radiation for curing the exposed material. For example, various commercially available nano-inks may be cured by exposure to Ultra-Violet (UV) light.

Thus, it should be appreciated that, in accordance with at least one disclosed embodiment, a selective laser sintering process may be used with alternating deposition of different materials, so that electrically conductive and insulating features are built during the manufacture process. The electrically conductive materials may include alloys and/or suspensions of silver, copper, gold, gallium, tin, lead, or plastic conductors or graphene or other nano-materials or combinations of such materials. Additionally, the material acting as a conductor in the part, device or structure may be porous. A porous conductor may be produced by an incomplete agglomeration of precursor particles to one another during the sintering process.

As a further alternative, jets of material may be deposited in successive layers upon a substrate.

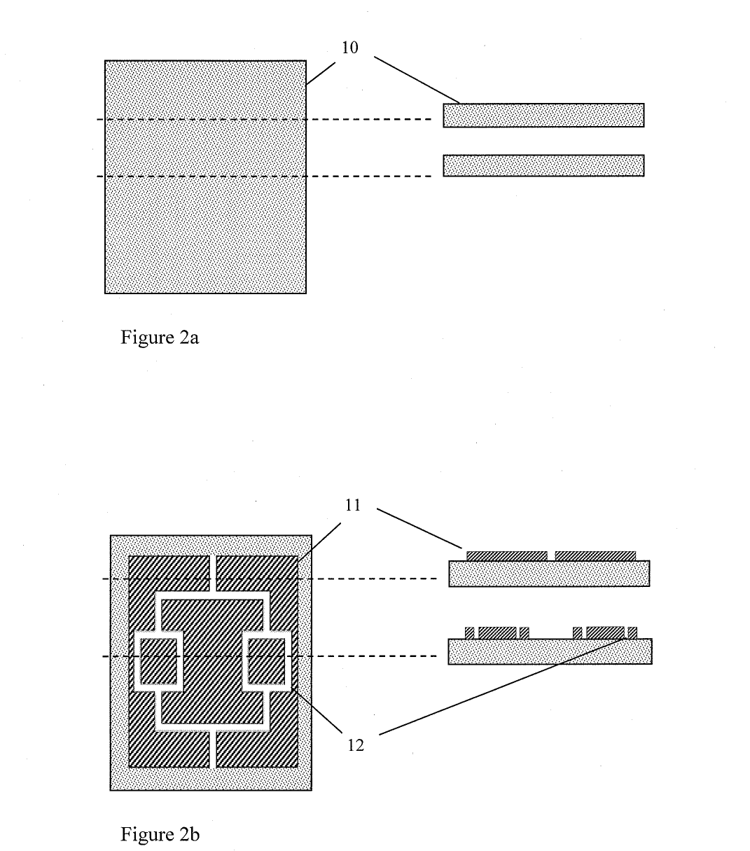

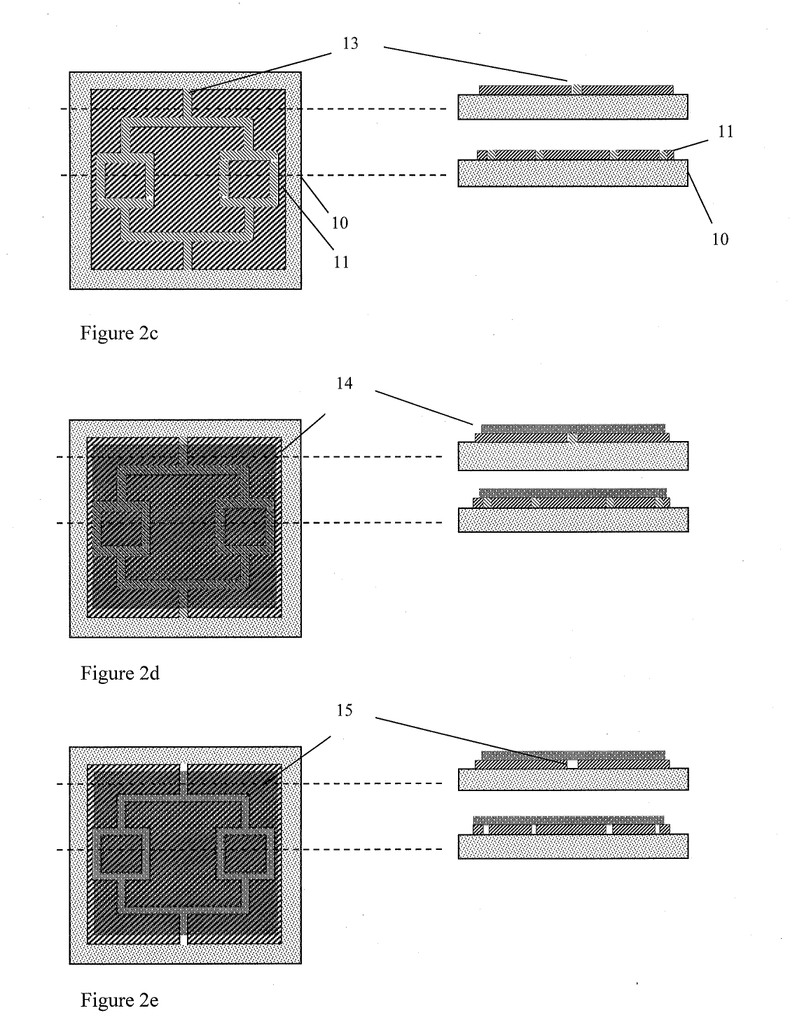

As mentioned above, the use of additive manufacturing to create the above explained embodiments is proposed. An example of the use of additive manufacturing to create assemblies of channels is shown in FIGS. 2a-e, which illustrates the fabrication of a channel layer within a form. It is understood that in one embodiment, the channels may be filled with liquid conductor to carry currents. In another embodiment, the channels carry insulating coolant adjacent to other, conducting pathways. In each Figure, the left is a top view and the right side is a cross-sectional view. FIG. 2a shows a substrate 10 of a layer of electrically-insulating material, viewed from above and in cross-section right side along the dashed lines of the top view (left side). In FIG. 2b, a new layer 11 of insulating material, with a fractal pattern of grooves 12, is deposited on the first layer 10. FIGS. 2c and 2d illustrate that a sacrificial material 13 (e.g., a non-electrically conductive material), for example water, polycarbonate and other thermoplastics, or wax, may be deposited in the grooves 12 to allow subsequent deposition of a roof 14 (e.g., a fully or partially overhanging structure) that may be, for example, a non-electrically conductive onto the grooves 12. The water or other sacrificial material 13 may be liquid at one or more stages of the fabrication process but may subsequently be blown out with compressed air, or removed with other means, leaving hollow channels 15, for example, in a fractal pattern, as shown in FIG. 2e. The channels 15 may be later used to conduct flowing coolant material or a conducting liquid (such as the liquid metal 8 as illustrated in connection with the first embodiment). It should be understood that one or more channels can be implemented through repetitive, serial application or parallel application of this technique.

As an alternative, a sacrificial material that is gaseous at one or more stages of the fabrication process can be used to form channels. As a result, the sacrificial material can be removed by pulling of a vacuum on the structure or by diluting the sacrificial material with other gases. For stabilization, during the entire fabrication process, the temperature and pressure of the manufacture form should be maintained below the critical point at which the sacrificial material will change states, e.g., boil.

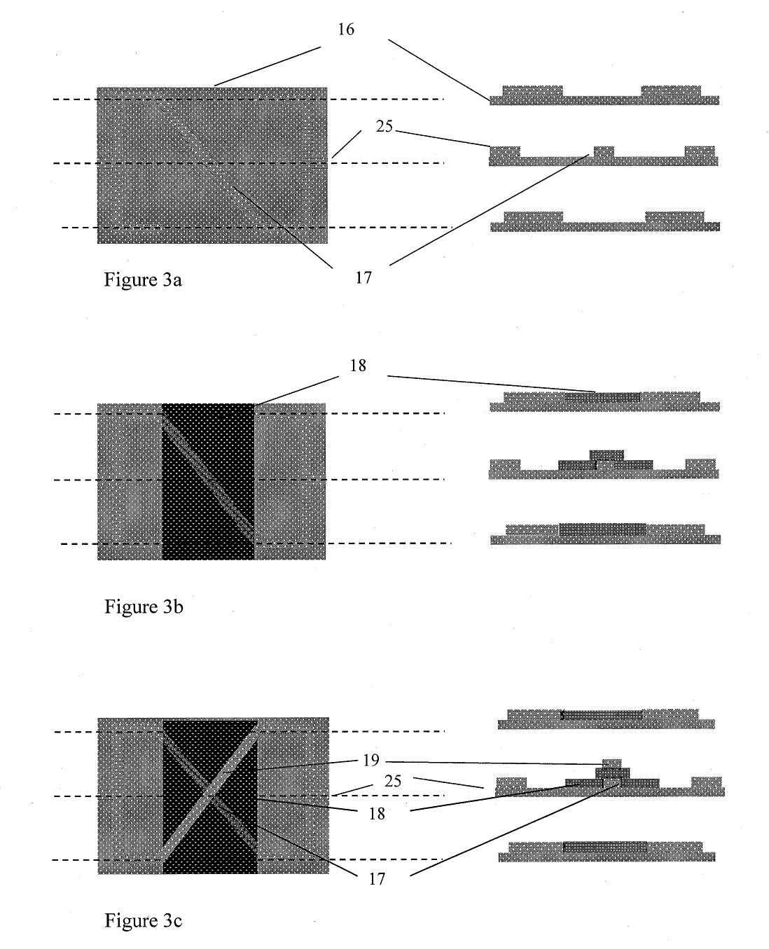

FIGS. 3a-c illustrate an example of woven conducting layers that may be manufactured as part of a fabricated electromagnet in accordance with at lest one disclosed embodiment. As shown in FIGS. 3a-c, conducting and insulating layers may be built in sequence. As above, in FIG. 3a to FIG. 3c, the left side of each figure is a top view and the right side is a cross-sectional view. FIG. 3a shows a substrate 16 of a layer of electrically-insulating material, upon which has been deposited traces of a conducting material 17, using, for example a nozzle, inkjet head, or other deposition method. As shown in FIG. 3b, another electrically-insulating layer 18 is then deposited. Subsequently, as shown in FIG. 3c, another conducting trace 19 is deposited and the two conductive traces 17 and 19 cross over each other, separated by the insulating layer 18. Similar cross-overs of conducting traces can be implemented multiple times and at different locations in order to achieve a Litz-like effect (i.e., in order to alleviate the skin effects of current alternating at high frequency). It should be noted that conductive tracers 17 and 19 represent a branching of the conductive path 25, and that such branching could be performed multiple times, with multiple branches at each branch point. Similar sets of conductive traces can be used to create a magnetic field upon the application of current through such conductive traces. In FIGS. 3a-c, each layer is shown as having equal thickness for illustrative purposes; however, it should be understood that in actual implementation, the layers may have unequal thicknesses, and some sections of each layer may have different thicknesses than other layers. It should be understood that in actual implementation, there may be traces in multiple planes, e.g., on top of each other and separated by insulators, so as to form a bundle of parallel conductive paths analogous to a bundle of insulated wires.

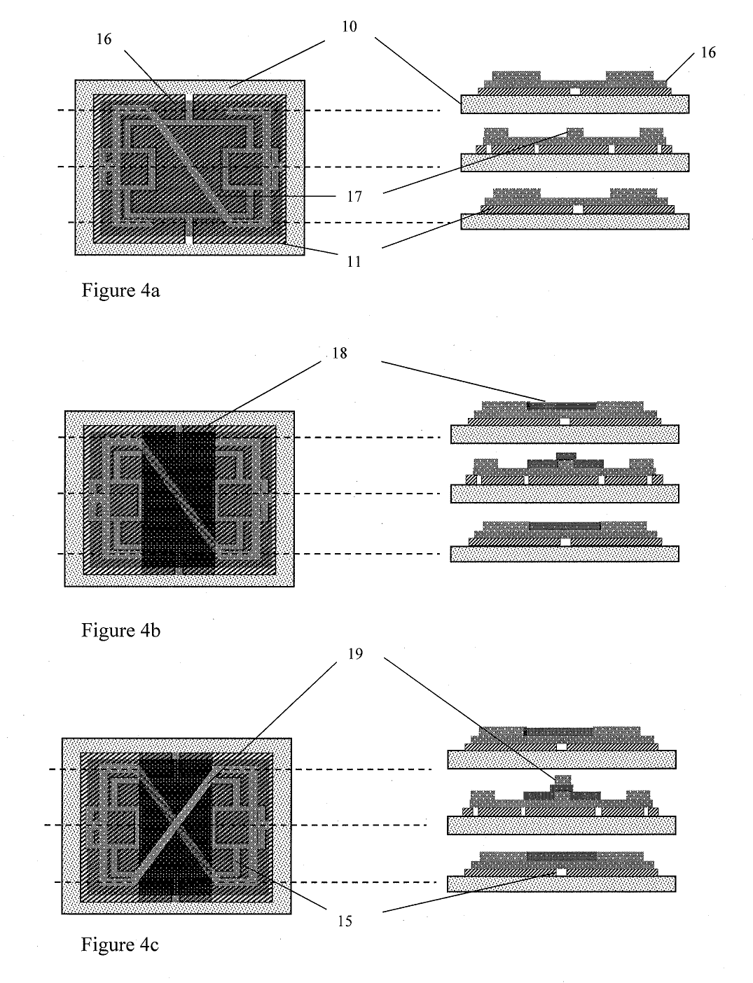

FIGS. 4a-c illustrate one example of the fractal cooling pattern shown in FIGS. 2a-e implemented along with the woven conductive layer pattern of FIGS. 3a-c through additive manufacturing. As shown in FIGS. 4a-c, discussion of the previously introduced reference numerals is omitted. Although not illustrated specifically in FIGS. 4a-c, it should be understood that cooling channels 15 may be fabricated so as to interweave among the conducting traces 17 and 19 in order to create more efficient cooling of the overall device.

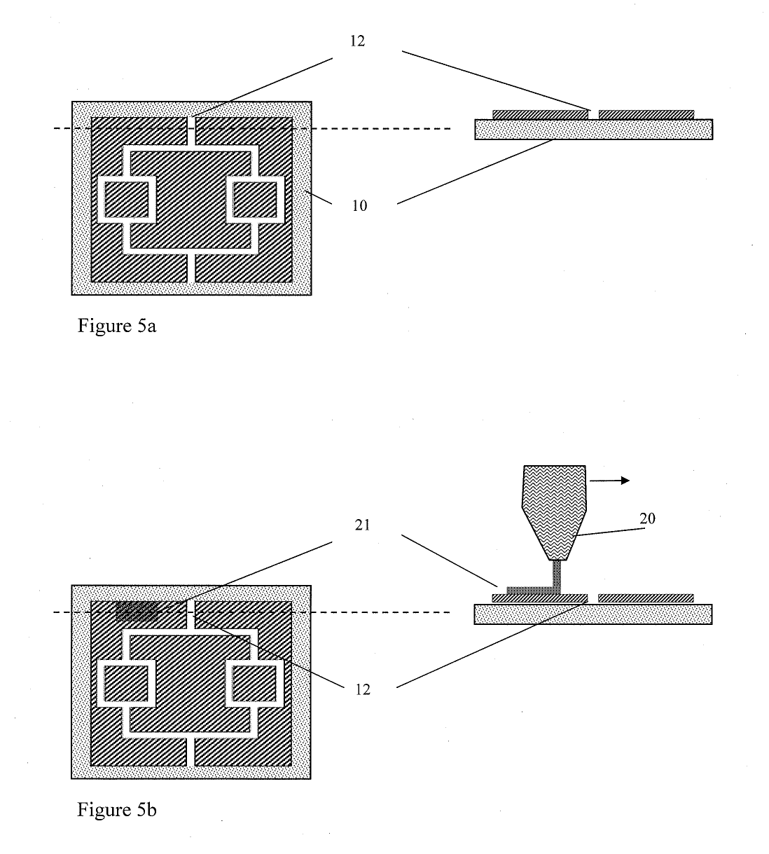

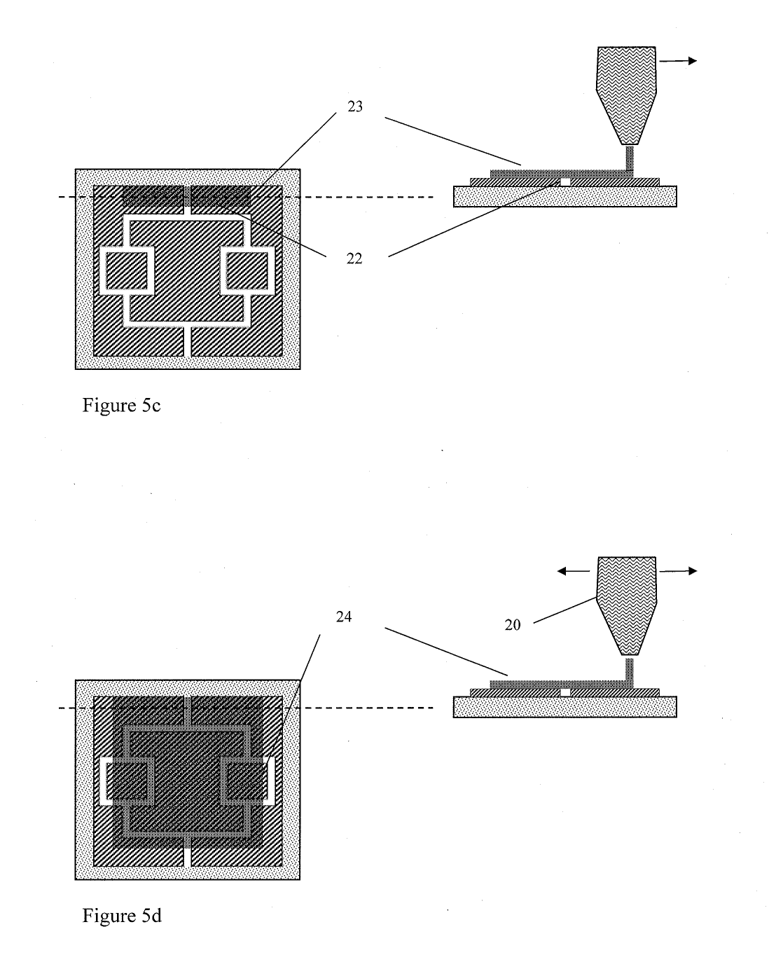

FIGS. 5a-d illustrate the fabrication process associated with the provision of a roof or overhanging structure over a groove in order to create a channel. That process begins with construction of a groove 12 constructed on a substrate 10, for example, as shown using parts 10 and 11 of FIGS. 2a-e. An extruding nozzle 20 or other deposition method (traveling in the direction shown with an arrow) may form a bead of insulating material 21 upon the layer 11. The surface tension (or other self-attractive forces) of the fluid in the extruded insulating material 21 maintains the integrity of the bead of extruded insulating material intact as the bead crosses the groove in area 23. As a result, the extruded insulating material 21 does not substantially sag or otherwise enter into the groove 12 in area 23. Thus, the traveling nozzle 20 creates a roof 22 in area 23 to the groove 12 after a single pass of the nozzle 20, and in area 24 after multiple rastering passes of the nozzle. In accordance with one implementation, the insulating material 21 can be cured after the nozzle 20 has passed in order to allow subsequent depositions as, for example, would be needed to create the multi-layer structures shown in FIGS. 2-4.

Although the process shown in FIGS. 5a-d illustrates a structure in which no sacrificial layer is needed to form a roof over the groove, it should be understood that depositing a roof via various techniques described herein can be performed in conjunction with the use of sacrificial materials as illustrated in FIGS. 2a-e, or can replace the need for sacrificial materials.

In accordance with at least one disclosed embodiment, additional features may be fabricated, for example, the material used to generate the electromagnetic field may be implemented using high-temperature or other types of superconductors, and/or coolants that may include gases. A superconductor is a substance that is able to conduct electricity or transport electrons with no resistance. Further, as part of additive manufacturing techniques used in fabricating electromagnets, magnetizable materials may be inserted into the structure, in order to modify the overall magnetic and/or electromagnetic properties of the structure. Further, as part of additive manufacturing techniques used in fabricating electromagnetic structures, electrical components and optical components may be inserted into the structure, to modify the overall magnetic and/or electromagnetic properties of the structure, part or device to provide information about the physical state of the structure, part or device, to measure, manage, or impede the flow of current across various wires, or to measure, manage, or impede magnetic fields around the structure, part or device.

It should also be understood that the configuration of electrical current paths provided by electromagnetic structures, parts or devices designed in accordance with the disclosed embodiments may be implemented dynamically. Thus, during operation of the device, the configuration(s) of electrical current paths may be altered to take into account changing conditions or requirements for the configuration of the magnetic field properties, e.g. strength, force, direction, uniformity, etc. For example, such magnetic fields may be utilized to direct nanoparticles, which have been placed in a patient's body or part of the body at a certain position and/or to redirect such nanoparticles to areas of the patient's body different thereto.

Additionally, the use of nanoparticles and small particles may facilitate the additive manufacturing process by decreasing the time required to cure each layer or section of layer.

Additionally, within the embodiments using the solid conductive and insulating materials the pattern of cooling channels implemented through additive manufacturing may employ a branching scheme such as a fractal scheme, which has advantages of cooling efficiency (as pointed out by Yongping Chen and Ping Cheng, in the article entitled “An experimental investigation on the thermal efficiency of fractal tree-like micro-channel nets”, published in the journal “International Communications in Heat and Mass Transfer, volume 32, pages 931-938, 2005).

Additionally, discrete components (e.g., transistors, diodes, optical transducers) may be deposited into the part or constructed functionally (e.g., as PN-layers), during the manufacturing process. Transducers, for example, could provide information about the temperature within the part during its operation.

Additionally, metalorganic decomposition can be incorporated as part of the additive manufacturing process in order to construct the conductive sections of each layer.

Further, electromagnets, electromagnetic materials, elements and devices may include a portion constructed to smoothly match impedances between a source of electrical energy and the remainder of the electromagnetic structure, for example to reduce reflections. Therefore, the impedance of the electromagnetic device, structure or part may be changed to reduce energy reflections.

Disclosed embodiments also include other forms of rapid prototyping in which the same principle of depositing two or more materials is used to create Litz wires. Utility is provided by these techniques because of the conventional difficulty of making and winding Litz wires to make electrical devices such as electromagnet coils in complex or size-constrained designs.

Conventionally, such designs are difficult to fabricate because of the physical constraints of winding Litz wires. Once these physical constraints are removed by eliminating the need to “wind” physical wire, conventionally available design software may be used to provide significantly improved designs that may be fabricated using rapid prototyping. As a result, disclosed embodiments provide the ability to form electrically conductive material in shapes, sizes and configurations that would not be conventionally possible with bundled Litz wires (e.g., due to limited bending angles of the bundles).

Although the disclosed embodiments have been described with respect to electromagnets for MRI, the inventive concepts would apply to other systems in which electromagnets are used, for example generators, energy converters, or alternators as well.

In the field of power generation and storage, the compactness of dynamo windings makes it challenging to implement Litz wire configurations. This wiring difficulty is attested to by an invention described by K Sivasubramanian, entitled “Multi-Turn, Stranded Coils for Generators”, submitted as patent application US 2010/0096944 A1, and published on Apr. 22, 2010. A flywheel using Litz wire to effectively store energy is described by P I-Pei Tsao, in his Ph.D. thesis from the Engineering Department of the University of California, Berkeley in 1999, entitled “An Integrated Flywheel Energy Storage System with a Homopolar Inductor Motor/Generator and High-Frequency Drive”. A particular advantage of the disclosed embodiments is that inter-leaved conductive paths can be created in the device that act in the same way as Litz wires, to reduce electrical resistance (and, therefore, reduce heat production) at high frequencies. Since many energy storage, motor, and generation devices operate at high velocities (and hence the coils operate at high frequencies), energy and heat savings achieved from the use of paths equivalent to Litz wires are important.

In at least one embodiment, a mathematical inverse problem may be specified in which certain magnetic fields are desired. This inverse problem may be solved with computerized algorithms, that can generate data to be used to prescribe the fabrication process. Thus, in accordance with an inverse problem framework, specified values or characteristics may be converted into details for designing a corresponding physical object or system. Thus, if specific characteristics of a magnetic field are required, at least one disclosed embodiment may involve designing a corresponding electromagnetic device, structure or part and fabricating that part utilizing the above-described fabrication processes and techniques.

In accordance with at least one disclosed embodiment, electromagnetic structures may be fabricated of relatively significant size in relation to devices fabricated conventionally using additive manufacturing. For example, a resulting structure may comprise at least 10 layers of electrically insulating materials and/or be at least 100 microns thick.

It should be understood that the disclosed embodiments may be implemented to provide significant utility in providing structures, devices and associated material for producing electromagnetic fields. For example, disclosed embodiments are particularly useful in fabricating such structures, devices and material in a rapid and/or efficient manner. Alternatively, it should be appreciated that disclosed embodiments may be used to fabricate structures that may be altered in a dynamic manner so as to provide more than one type, strength or configuration of electromagnetic field. As mentioned above, electromagnetic structures, parts or devices that can be dynamically altered have particular utility, for example, so that current configuration(s) may be altered to take into account changing conditions or requirements for the configuration of the magnetic field properties, e.g. strength, force, direction, uniformity, etc. Such dynamically controllable magnetic fields may be used in directing nanoparticles. For example, such magnetic fields may be utilized to direct nanoparticles, which have been placed in a patient's body or part of the body at a certain position and/or redirect such nanoparticles to areas of the patient's body different thereto.

While the present disclosure includes various disclosed embodiments, it should be evident that many alternatives, modifications and variations will be apparent to those skilled in the art. Accordingly, the various disclosed embodiments, as set forth above, are intended to be illustrative, not limiting. Various changes may be made without departing from the spirit and scope of the invention.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

As a result, it will be apparent for those skilled in the art that the illustrative embodiments described are only examples and that various modifications can be made within the scope of the invention as defined in the appended claims.

What is claimed:

1. A process for fabricating a three-dimensional electromagnetic structure by additive manufacturing, the process comprising:
depositing at least one electrically insulating material in a plurality of successive layers upon a substrate,
wherein the structure is configured to include at least one electrically conductive material that produces at least one electromagnetic field when voltage is applied or current is injected to the electrically conductive material by a power source.

2. The process of claim 1, further comprising providing the electrically conductive material.

3. The process of claim 2, further comprising interweaving the electrically conductive material to reduce electrical resistance at high frequencies due to skin effect.

4. The process of claim 2, further comprising exposing at least one layer of electrically insulating material to light or heat radiation to cure the at least one layer of material.

5. The process of claim 2, wherein the deposition of the electrically insulating material and the at least one conductive material provides at least one conductive path that divides into multiple branches.

6. The process of claim 2, wherein the electrically conductive material includes at least one of alloys or suspensions of silver, copper, gold, gallium, tin, lead, plastic conductors, other nano-materials, a semiconductor, a metal or alloy of metals, or combinations thereof, a slurry, solution, or other composite or contains at least one of metal flakes, conductive nanoparticles, grapheme, or a metalorganic material.

7. The process of claim 2, wherein the at least one insulating material includes at least one of particles, ceramic particles, polyimides, polycyanurates, and/or blends or co-polymers thereof.

8. A three-dimensional electromagnetic structure fabricated by additive manufacturing, the structure being fabricated by the process comprising:
depositing at least one electrically insulating material in a plurality of successive layers upon a substrate, wherein the structure is configured to include at least one electrically conductive material that produces at least one electromagnetic field when voltage is applied or current is injected to the electrically conductive material by a power source.

9. The structure of claim 8, wherein a strength of the produced electromagnetic field is at least one Gauss.

10. The structure of claim 8, wherein the structure further comprises the electrically conductive material for producing the at least one electromagnetic field when voltage is applied or current is injected.

11. The structure of claim 10, wherein an impedance of the electromagnetic structure changes to reduce reflections of current entering the structure from the power source.

12. The structure of claim 10, wherein the electrically conductive material is interwoven to reduce electrical resistance at high frequencies due to skin effect

13. The structure of claim 12, wherein the reduction in electrical resistance provides at least one of improved efficiency in a circuit designed to convert direct current to alternating current, a circuit designed to convert alternating current to direct current, a circuit designed to convert direct current at one voltage to direct current at another voltage, or a circuit designed to convert alternating current at one voltage to alternating current at another voltage.

14. The structure of claim 10, wherein at least one part of the structure is exposed to light or heat radiation to cure at least one material deposited as part of the structure or on the structure.

15. The structure of claim 10, wherein the structure comprises at least 10 layers of electrically insulating materials.

16. The structure of claim 10, wherein the device is at least 100 microns thick.

17. The structure of claim 10, wherein the at least one insulating material separates the electrically conductive material into a conductive path that divides into multiple branches.

18. The structure of claim 10, wherein a material is deposited that is or becomes the conductive material.

19. The structure of claim 18, wherein the material that is or becomes the conductive material has a resistivity less than 10⁻⁸ Ω-m.

20. The structure of claim 18, wherein the material that is or becomes the conductive material includes at least one of alloys or suspensions of silver, copper, gold, gallium, tin, lead, plastic conductors, other nano-materials, a semiconductor, a metal or alloy of metals, or combinations thereof, a slurry, solution, or other composite or contains at least one of metal flakes, conductive nanoparticles, grapheme, or a metalorganic material.

21. The structure of claim 18, wherein the material that is or becomes the conductive material is porous.

22. The structure of claim 21, wherein coolant flows through the porous conductive material.

23. The structure of claim 22, wherein liquid conducting material flows through the porous conductive material.

24. The structure of claim 8, wherein the insulating material includes at least one of particles, ceramic particles, polyimides, polycyanurates, and/or blends or co-polymers thereof.

25. The structure of claim 8, wherein at least one magnetizable material is deposited into the structure.

26. The structure of claim 8, wherein a material is deposited into the structure that is or becomes a superconductor.

27. The structure of claim 8, wherein the electrically conductive material is provided so as to flow through the structure.

28. The structure of claim 27, wherein the electrically conductive material is propelled to flow through the structure using a magnetohydrodynamic pump or a peristaltic pump.

29. The structure of claim 27, wherein the structure further comprises valves configured to control the flow of at least some of the liquid electrically conductive material.

30. The structure of claim 27, wherein the electrically conductive material is a plasma.

31. The structure of claim 8, wherein the three dimensional structure includes at least one channel for flow of a coolant.

32. The structure of claim 31, wherein the at least one channel is one of a plurality of channels and at least some of the channels branch in a fractal pattern.

33. The structure of claim 31, wherein the coolant is at least one of conductive, insulating, liquid, gas, plasma, or liquid nitrogen or helium.

34. The structure of claim 31, wherein the at least one channel is fabricated through deposition of a sacrificial material that is subsequently removed.

35. The structure of claim 31, wherein the at least one channel is fabricated by depositing a layer of insulating material onto a grooved layer, so that self-attractive forces within the insulating layer prevent substantial entry of the insulating material into at least one groove during the deposition process.

36. The structure of claim 8, wherein in the fabrication process further comprises insertion of electrical or optical components into the structure.

37. The structure of claim 8, wherein the solution of an inverse problem for a desired magnetic field configuration provided with the aid of a computer is implemented in the design of the fabrication process.

38. The structure of claim 8, wherein the solution of an inverse problem for a desired magnetic field configuration provided with the aid of a computer is implemented dynamically to alter flow of electrical currents in the structure.

39. A process for fabricating a three-dimensional electromagnetic structure by additive manufacturing, the process comprising:
depositing at least one electrically insulating material in a plurality of successive layers upon a substrate,
wherein the structure is configured to include at least one electrically conductive material that produces at least one current when a magnetic field is applied.

40. The process of claim 39, further comprising providing the electrically conductive material.

41. The process of claim 40, further comprising interweaving the electrically conductive material to reduce electrical resistance at high frequencies due to skin effect.

42. The process of claim 40, further comprising exposing at least one layer of electrically insulating material to light or heat radiation to cure the at least one layer of material.

43. The process of claim 40, wherein the deposition of the electrically insulating material and the at least one conductive material provides at least one conductive path that divides into multiple branches.

44. The process of claim 40, wherein the electrically conductive material includes at least one of alloys or suspensions of silver, copper, gold, gallium, tin, lead, plastic conductors, other nano-materials, a semiconductor, a metal or alloy of metals, or combinations thereof, a slurry, solution, or other composite or contains at least one of metal flakes, conductive nanoparticles, grapheme, or a metalorganic material.

45. The process of claim 40, wherein the at least one insulating material includes at least one of particles, ceramic particles, polyimides, polycyanurates, and/or blends or co-polymers thereof.

46. A three-dimensional electromagnetic structure fabricated by additive manufacturing, the structure being fabricated by the process comprising:
depositing at least one electrically insulating material in a plurality of successive layers upon a substrate, wherein the structure is configured to include at least one electrically conductive material that produces at least one current when a magnetic field is applied.
